(19) United States
(12) Patent Application Publication
(10) Pub. No.: US 2025/0362940 A1
(43) Pub. Date: Nov. 27, 2025

(54) METHOD AND SYSTEM FOR PROVIDING DISTRIBUTED DISPLAY SYSTEM FOR HPC AND GRID COMPUTE ENVIRONMENTS

(71) Applicants: Shamir Shmuel SNIR, Kadima (IL); Shimshon NAGAR, Netanya (IL)

(72) Inventors: Shamir Shmuel SNIR, Kadima (IL); Shimshon NAGAR, Netanya (IL)

(21) Appl. No.: 19/230,788

(22) Filed: Jun. 6, 2025

Related U.S. Application Data
(60) Provisional application No. 63/565,928, filed on Mar. 15, 2024.

(51) Int. Cl. G06F 9/451; G06F 3/14; H04L 65/1045; H04L 65/1069; H04L 65/1073

(52) U.S. Cl. CPC G06F 9/452; G06F 3/1454; H04L 65/1045; H04L 65/1069; H04L 65/1073

(57) ABSTRACT

The present invention relates generally to a system designed to provide application graphical display while using High-Performance Computing systems which are based on GRID systems, in which applications can be executed on any one out of multiple compute nodes while the user interactive session (also known as an X session) is viewed from a control session. In specific, the invention relates generally to a system which creates a separate selfsustained X Display session for each launched application, while a list of available sessions is provided to the main user graphical session allowing interacting with the remote application without directly affecting its integrity in case of disconnection.

### DISCUSSION OF RELATED ART

In the early days of HPC, interactions were primarily command-line based. Users had to be physically present at the computing facility or use basic terminal emulation to interact with these systems. Advent of Graphical User Interfaces (GUIs): With the advent of GUIs, tools like XWindows system provided a framework for building GUIs on UNIX-like operating systems. This allowed for more complex interactions with HPC systems. As HPC systems became more powerful and complex, the need for more sophisticated interaction tools grew. This led to the development of remote viewer tools like VNC, Nonmachine, Exceed etc. . . . These tools allowed users to interact with HPC systems as if they were sitting in front of them, providing a significant boost in usability. Most remote desktop tools used for HPC systems had been based on a centralized Display Manager allowing the user to connect by using a dedicated viewer, while any application running on any of the HPC separate nodes is configured to send its graphical output to the Display Manager running on a separate machine having a Display Manager application.

### SUMMARY OF THE INVENTION

The present invention provides a method for enabling remote GUI based application within a distributed computer architecture, the method comprising:
Assigning and scheduling at least one available computer node for executing a requested task, utilizing a batch scheduler;
Initiating a dedicated Display Manager on the selected remote compute node to start an RFB (Remote Framebuffer) server;
Generating a Dedicated Display Proxy of the RFB server;
Publishing the Dedicated Display Manager, including registering the RFB server information in a display management system;
Initiating the execution of an application on the assigned computer node;
Generating a visual representation in the form of a link on the user's work environment either Desktop, application or web application, enabling the user to view and interact with the application via the Distributed Display Manager.

The present invention disclosed a system designed to support Graphical Display distribution in a computer environment managed by a central Grid or batch scheduler having multiple compute nodes available for performing any application task. The environment is then accessed by a user which is connected to one of the compute nodes using a remote viewer application, the user is then using the Grid or Batch system to schedule the execution of an application which requires graphical interactivity with the user. The Grid system then selects any of the available compute nodes suitable for the task, initiating a dedicated Display manager on the selected compute node, initiate the execution of the application on the selected compute node and redirect the application Display output to the dedicated Display manager, once the Display manager is ready, the user's remote viewer session receives the necessary information in order to connect to the dedicated Display manager using a remote viewer application.

The present invention provides a method for enabling remote GUI based application on user desktop within a distributed computer architecture, the method comprising:
Enabling users to send requests for launching new app;
Assigning and scheduling at least one available computer node for executing a requested app, utilizing a batch scheduler;
Initiating a dedicated Virtual Display Manager (DDM) on the selected remote compute node;
Generating a Dedicated Virtual Display Proxy of RFB server type;
Publishing the Dedicated Virtual Display Manager, including registering the RFB server information in a Distributed Display Management system;
Initiating the execution of an application on the assigned computer node;
Generating a visual representation in the form of either code or link on the user's desktop or as weblink in a web application, enabling the user to view and interact with the application via the Distributed Display Manager.

According to some embodiments of the present invention the weblink is provided as a clickable icon, URL, or desktop shortcut.

According to some embodiments of the present invention the DDM maintains session persistence to allow re-connection after network disruption

According to some embodiments of the present invention when the application is closed, the system removes the link to free up resources and maintain desktop organization.

According to some embodiments of the present invention the ddedicated Virtual Display Proxy serves as an intermediary, facilitating communication and data transfer between the computing node and the display system.

when the code is executed, with its execution being redirected to ensure that it launches within the configured display environment.

According to some embodiments of the present invention upon receiving an instruction to close the application, the system closes the application, the Dedicated Virtual Display Proxy, and the Dedicated Virtual Display Manager.

According to some embodiments of the present invention the use can establish a connection either upon making the request or automatically upon receipt of the connection string.

The present invention discloses A distributed display system for remote GUI application interaction in a high-performance computing (HPC) environment, comprising:
a dispatching system grid configured to receive application requests and assign compute nodes using a batch scheduler;
at least one compute node configured to execute applications and initiate a dedicated virtual display manager (DvDM) and a virtual display proxy (DvDP);
a distributed display manager (DDM) configured to register DvDM and DvDP instances and associate them with user sessions;
a distributed display presenter (DDP) residing on a user device, configured to receive session information from the DDM and present access options to the user; and generating a visual representation in the form of either code or link on the user's desktop or as weblink in a web application, enabling the user to view and interact with the application via the Distributed Display Manager
a distributed display viewer (DDV) configured to connect to the DvDM or DvDP and allow user interaction with the application.

According to some embodiments of the present invention the DDM is further configured to manage concurrent sessions from multiple users and track session state.

According to some embodiments of the present invention the compute node is a virtualized instance running in a container or hypervisor-managed environment

According to some embodiments of the present invention the weblink is provided as a clickable icon, URL, or desktop shortcut.

According to some embodiments of the present invention the DDM maintains session persistence to allow re-connection after network disruption

According to some embodiments of the present invention when the application is closed, the system removes the link to free up resources and maintain desktop organization.

According to some embodiments of the present invention the ddedicated Virtual Display Proxy serves as an intermediary, facilitating communication and data transfer between the computing node and the display system.

According to some embodiments of the present invention when the code is executed, with its execution being redirected to ensure that it launches within the configured display environment.

According to some embodiments of the present invention upon receiving an instruction to close the application, the system closes the application, the Dedicated Virtual Display Proxy, and the Dedicated Virtual Display Manager

### BRIEF DESCRIPTION OF THE DRAWINGS

The present invention will be more readily understood from the detailed description of embodiments thereof made in conjunction with the accompanying drawings of which:

FIG. 1 illustrates a block diagram, depicting the activity and configuration of display system for HPC and grid compute environments according to some embodiments of the present invention.

FIG. 2 illustrates a flowchart, the activity of the user desktop according to some embodiments of the present invention.

FIG. 3 illustrates a flowchart, depicting the Dispatching System Grid according to some embodiments of the present invention.

FIG. 4 illustrates a flowchart, depicting the activity of the computing node according to some embodiments of the present invention.

FIG. 5 illustrates a flowchart, depicting the activity of the Distributed Display manager according to some embodiments of the present invention.

### DETAILED DESCRIPTION OF SOME EMBODIMENTS OF THE INVENTION

Before explaining at least one embodiment of the present invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The following table provides definitions of terms used throughout this application.

| Term | Definition |
|---|---|
| “Dispatching | A System controlling a Grid of computing nodes, |
| System” Grid | responsible for collecting requests for execution |
| | of code and assigning dispatching and managing |
| | said execution of the requested code. |
| “DvDM” | A virtual X based Display manager generated for |
| Dedicated | displaying the executed Application only. |
| Virtual | |
| Display | |
| manager | |
| “DvDP” | an RFB based proxy responsible for displaying and |
| Dedicated Virtual | controlling a single “DvDM” instance. |
| Display Proxy | |
| “DDM” | Registers any Dedicated Display Session activity, |
| Distributed | holds the information of any DvDM and DDP activity, |
| Display | It provides the User Desktop with the information of |
| Manager | all his active Display sessions. |
| “DDP* | Connects to a “DDM” system, collects the list |
| Distributed | of “DvDP” entries related to user session and |
| Display Presenter. | display them in the user Desktop. |
| “DDV” | a Viewer application designed to connect to a “DvDP” |
| Distributed | or “DvDM” display and control the session from |
| Display Viewer | the Users Working Environment. |
| “Application” | Set of instructions added to a “code” executed in |
| | a distributed computing environment. |
| “code” | A program launched by a user. |

A system comprises of multiple computers utilized by a centralized dispatching system, by which the user is executing computer code having a graphical interface, the code is then executed on any of the available computers by first opening a graphical display manager on the selected computer, redirecting the code Display to the display manager and updating the user environment with the information required to access the Display manager.

A system comprises of multiple computers utilized by a centralized dispatching system, by which the user is executing computer code having a graphical interface, the code is then executed on any of the available computers by first opening a graphical display manager on the selected computer, redirecting the code Display to the display manager a session control application which registers the display manager information, the user remote viewer is then contacting the session control application and connecting to the remote display manager using the provided connection information.

A system comprises of multiple computers utilized by a centralized dispatching system, by which the user is executing computer code having a graphical interface, the code is then executed on any of the available computers by first opening a graphical display manager on the selected computer, redirecting the code Display to the display manager a session control application which registers the display manager information, the user remote viewer is then contacting the session control application and connecting to the remote display manager using the provided connection information. Once a connection has been established the user can send control events to the display manager and application

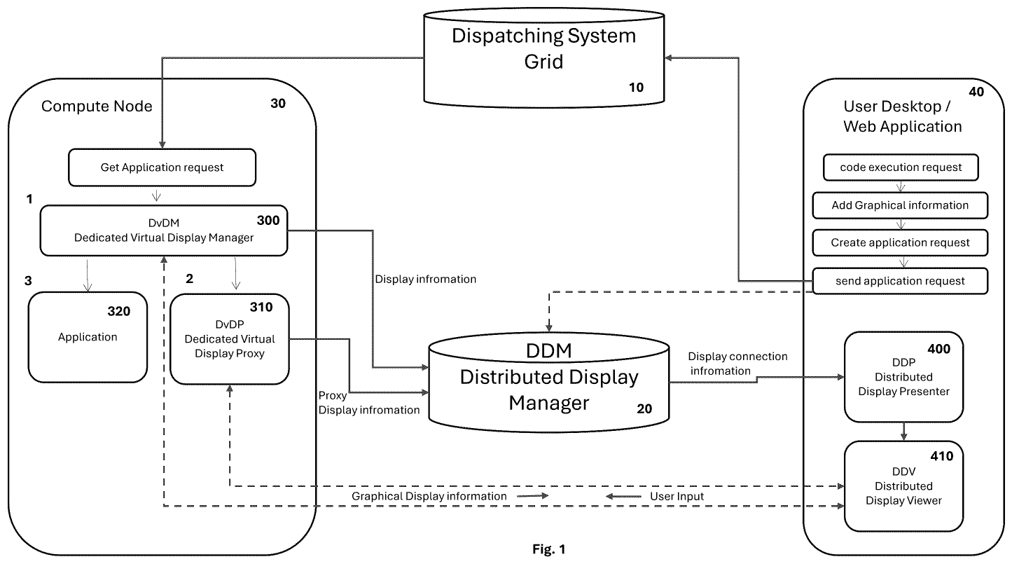

FIG. 1 illustrates a block diagram, depicting the activity and configuration of display system for HPC and grid compute environments according to some embodiments of the present invention.

The present invention is comprised of dispatching System Grid 10, and DDM Distributed Display Manager 20 which enables user desktop 40, performing the application requests at remote compute node 30. The user desktop sends application request and the dispatching System Grid 10 assign Compute node for execution of the application requests.

The compute node 30 is executing the Application requests which include instructions for: launching the DvDM dedicated Virtual display manger 300 and initiating DvDP dedicated Virtual display proxy 310

The Virtual display proxy 310 connects to the generated DvDM dedicated Virtual display manager 300 and directs the application 320 graphical output to the DvDM dedicated Virtual display manager 300.

The Virtual display proxy 310 further registers the information of the DvDP dedicated Virtual display proxy 310 and the DvDM dedicated Virtual display manager 300, at the DDM Distributed Display Manager 20.

The DDM 20 provides the user instructions for connecting to the relevant DvDP dedicated Virtual display proxy 310 or DvDM dedicated Virtual display manager 300 server by registering the information in the user DDP (Distributed Display presenter).

The DDM is further configured to manage concurrent sessions from multiple users and track session state and maintaining session persistence to allow re-connection after network disruption.

The DDP (Distributed Display presenter) 400 at the user desktop generates visual representation object in the form of a link or an icon or web application link enabling the active DvDP or DvDM to display the application, allowing the user to view and interact with the application using the DDV Distributed Display Viewer 410.

The distributed display viewer (DDV) configured to connect to the DvDM or DvDP and allow user interaction with the application.

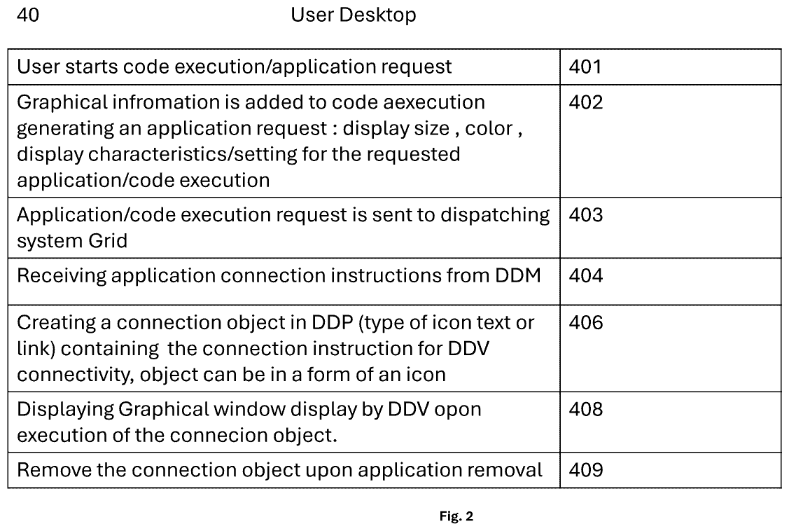

FIG. 2 presents a detailed flowchart illustrating the sequence of operations for user interaction with the desktop environment under certain embodiments of this invention.

The process begins with the user initiating a request for a new code execution through the batch system (Reference 401). The system then aggregates the graphical information required, in order to properly display the application and creates an application request (Reference 402) the application request is then sent to the dispatching system (Reference 403), which assigns a compute node and initiates the application execution.

Once the application had been launched, the Distributed Display Manager (DDM) registers the session by providing the connection instructions to the DDP (Reference 404), the DDM establishes session by a correlating connection object such as link (Reference 406) providing the user with a connection string containing the detailed instructions for connecting a DDV (Distributed Display Viewer) with the relevant DvDP or DvDM server (Reference 408).

The user can then establish a connection either upon making the request or automatically upon receipt of the connection string.

When the application is terminated, the system cleans up the associated session, including removing the connection object from the user interface, thereby releasing system resources and preserving the organization of the desktop environment (Reference 409).

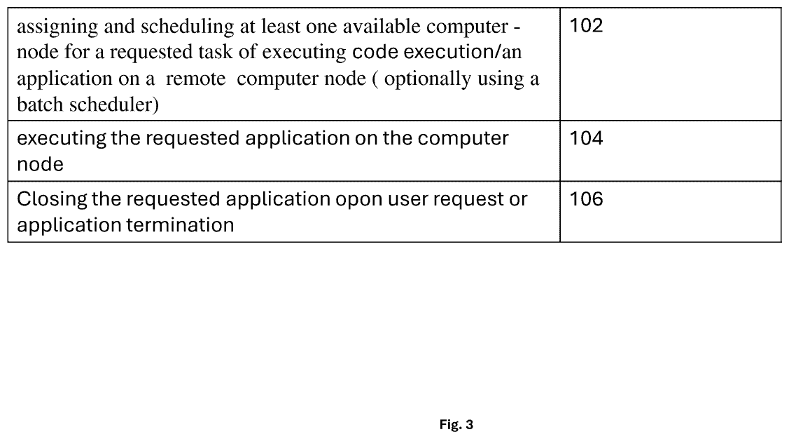

FIG. 3 depicts a flowchart outlining the operational flow of the Dispatching System Grid, as per certain embodiments of this invention.

The Dispatching System Grid is responsible for orchestrating the execution of user-requested applications across available compute nodes within the distributed environment.

The process initiates with the assignment and scheduling of at least one available computer node to carry out a specific task, which involves executing an application on a remote computer node. This assignment may be optionally utilizing a batch scheduler for to optimize resource utilization and execution timing (Reference 102).

Once a compute node has been assigned, the dispatching system initiates execution of the requested application on the designated node (Reference 104), triggering the sequence of events required to establish the remote display session.

Upon application termination, the dispatching system proceeds to shut down the application and any associated display or proxy processes on the compute node (Reference 106), thereby ensuring proper resource release and session cleanup.

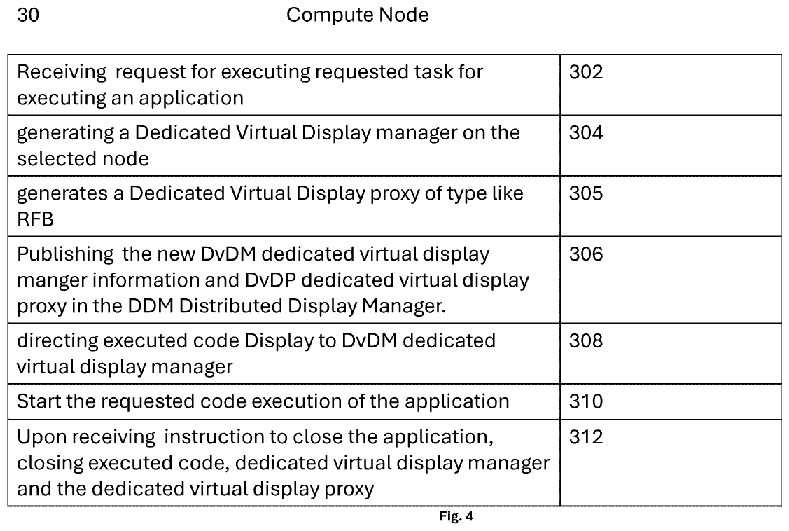

FIG. 4 offers a comprehensive flowchart that illustrates the sequence of operations conducted by a computing node within certain embodiments of the present invention. The process initiates with the computing node receiving a request to execute a specific task, which involves running an application (Reference 302). This step is critical as it sets into motion the sequence of events that enable application execution in a distributed environment.

Following the initial request, the system proceeds to generate a Dedicated Virtual Display Manager (DvDM) on the selected node (Reference 304). The DvDM establishes a graphical display environment specifically allocated for the upcoming application session, ensuring that the graphical output can be managed independently and securely.

Subsequently, a Dedicated Virtual Display Proxy is generated, utilizing a protocol such as Remote Frame Buffer (RFB). This proxy serves as an intermediary, facilitating communication and data transfer between the computing node and the display system (Reference 305).

The next step involves publishing the new dedicated virtual display manager and registering both dedicated virtual display manager and dedicated virtual display proxy information within the distributed display manager systems (Reference 306). This registration is crucial for integrating the new display manager into the existing ecosystem, allowing other components to recognize and interact with it.

This registration process ensures that the session metadata, including connection endpoints and session identifiers, are made accessible to other system components, such as the user's Distributed Display Presenter (DDP).

Following registration, the compute node redirects the graphical output of the application to the instantiated DvDM (Reference 308). This redirection step ensures that any GUI elements produced by the application are transmitted to the appropriate graphical display context

The application is then executed and launched within the configured display session, utilizing the DvDM as its visual output environment (Reference 310). This approach ensures the application's GUI is fully accessible to the user through the associated DvDP and maintains isolation between sessions.

The application is then executed and launched within the configured display session, utilizing the DvDM as its visual output environment (Reference 310). This approach ensures the application's GUI is fully accessible to the user through the associated DvDP and maintains isolation between sessions.

Finally, upon receiving an instruction to close the application, the system closes the application, the Dedicated Virtual Display Proxy, and the Dedicated Virtual Display Manager (Reference 312). This comprehensive closure is crucial for releasing resources, ensuring security, and maintaining the integrity of the system's operational environment.

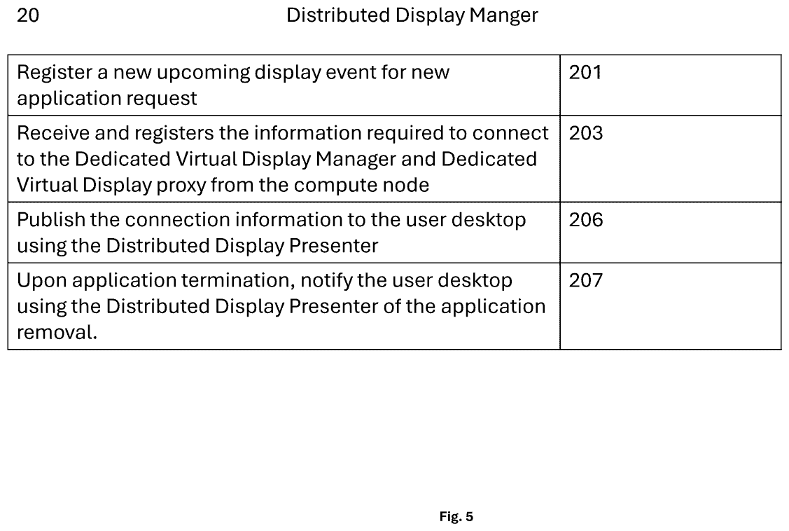

FIG. 5 illustrates a flowchart, depicting the activity of the Distributed Display manager according to some embodiments of the present invention. The process begins with the DDM registering a new display session in response to an incoming application request (Reference 201). This includes initializing the tracking of a new Dedicated Virtual Display Manager (DvDM) or Dedicated Virtual Display Proxy (DvDP) that will serve the upcoming graphical session;

Receiving and registering the information required to connect to the executed code display using the generated Dedicated Virtual Display manager or Dedicated Virtual Display Proxy (Reference 203). This information includes identifiers and communication endpoints necessary for the user-side Distributed Display Presenter (DDP) and Distributed Display Viewer (DDV) to access the display session.

Publishing the provided information with the users Distributed Display Presenter (Reference 400) This allows the DDP to generate a visual connection object—such as a link or icon—on the user's desktop or interface, thereby enabling user access to the application session.

Upon termination of the application, the DDM sends a notification to the DDP indicating that the associated display session has ended (Reference 207). This triggers the removal of the visual connection object and ensures proper cleanup of the user interface (Reference 207).

The system of the present invention may include, according to certain embodiments of the invention, machine-readable memory containing or otherwise storing a program of instructions which, when executed by the machine, implements some or all of the apparatus, methods, features, and functionalities of the invention shown and described herein. Alternatively, or in addition, the apparatus of the present invention may include, according to certain embodiments of the invention, a program as above which may be written in any conventional programming language, and optionally a machine for executing the program such as but not limited to a general-purpose computer which may optionally be configured or activated in accordance with the teachings of the present invention. Any of the teachings incorporated herein may, wherever suitable operate on signals representative of physical objects or substances.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field-programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

It is appreciated that software components of the present invention including programs and data may, if desired, be implemented in ROM (read-only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer-or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

What is claimed is:

1. A method for enabling remote GUI based application on user desktop within a distributed computer architecture, the method comprising:
Enabling a user to send a request for launching new app;
Assigning and scheduling at least one available computer node for executing the requested app, utilizing a batch scheduler;
Initiating a dedicated Virtual Display Manager (DDM) on the selected remote compute node;
Generating a Dedicated Virtual Display Proxy of RFB server type;
Publishing the Dedicated Virtual Display Manager, including registering the RFB server information in a Distributed Display Management system;
Initiating the execution of an application on the assigned computer node;
Generating a visual representation in the form of either code or link on the user's desktop or as weblink in a web application, enabling the user to view and interact with the application via the Distributed Display Manager.

2. The method of claim 1, wherein the weblink is provided as a clickable icon, URL, or desktop shortcut.

3. The method of claim 1, wherein the DDM maintains session persistence to allow re-connection after network disruption

4. The method of claim 1, wherein when the application is closed, the system removes the link to free up resources and maintain desktop organization.

5. The method of claim 1, wherein the ddedicated Virtual Display Proxy serves as an intermediary, facilitating communication and data transfer between the computing node and the display system.

6. The method of claim 1, wherein when the code is executed, with its execution being redirected to ensure that it launches within the configured display environment.

7. The method of claim 1, wherein upon receiving an instruction to close the application, the system closes the application, the Dedicated Virtual Display Proxy, and the Dedicated Virtual Display Manager.

8. The method of claim 1, wherein the use can establish a connection either upon making the request or automatically upon receipt of the connection string.

10. A distributed display system for remote GUI application interaction in a high-performance computing (HPC) environment, comprising:
a dispatching system grid configured to receive application requests and assign compute nodes using a batch scheduler;
at least one compute node configured to execute applications and initiate a dedicated virtual display manager (DvDM) and a virtual display proxy (DvDP);
a distributed display manager (DDM) configured to register DvDM and DvDP instances and associate them with user sessions;
a distributed display presenter (DDP) residing on a user device, configured to receive session information from the DDM and present access options to the user; and generating a visual representation in the form of either code or link on the user's desktop or as weblink in a web application, enabling the user to view and interact with the application via the Distributed Display Manager
a distributed display viewer (DDV) configured to connect to the DvDM or DvDP and allow user interaction with the application.

11. The system of claim 10, wherein the DDM is further configured to manage concurrent sessions from multiple users and track session state.

12. The system of claim 10, wherein the compute node is a virtualized instance running in a container or hypervisor-managed environment

13. The system of claim 10, wherein the weblink is provided as a clickable icon, URL, or desktop shortcut.

14. The system of claim 10, wherein the DDM maintains session persistence to allow re-connection after network disruption

15. The system of claim 10, wherein when the application is closed, the system removes the link to free up resources and maintain desktop organization.

16. The system of claim 10, wherein the ddedicated Virtual Display Proxy serves as an intermediary, facilitating communication and data transfer between the computing node and the display system.

17. The system of claim 10, wherein when the code is executed, with its execution being redirected to ensure that it launches within the configured display environment.

18. The system of claim 10, wherein upon receiving an instruction to close the application, the system closes the application, the Dedicated Virtual Display Proxy, and the Dedicated Virtual Display Manager.
